(19) United States
(12) Patent Application Publication
(10) Pub. No.: US 2021/0276437 A1
(43) Pub. Date: Sep. 9, 2021

(54) ENERGY SUPPLY DEVICE FOR PROVIDING ELECTRICAL ENERGY TO A MOTOR VEHICLE, METHOD FOR OPERATING AN ENERGY SUPPLY DEVICE, METHOD FOR MANUFACTURING ENERGY SUPPLY DEVICES, AND ENERGY SUPPLY ARRANGEMENT

(71) Applicant: AUDI AG, Ingolstadt (DE)

(72) Inventor: Martin DEHM, Monheim (DE)

(21) Appl. No.: 17/195,283

(22) Filed: Mar. 8, 2021

(30) Foreign Application Priority Data
Mar. 9, 2020 (DE) 102020106347.4

(51) Int. Cl. B60L 53/16; B60L 53/18; B60L 53/22; B60L 53/66

(52) U.S. Cl. CPC B60L 53/16; B60L 53/66; B60L 53/22; B60L 53/18

(57) ABSTRACT

An energy supply device for providing electrical energy to a motor vehicle comprises an energy supply unit arranged in a housing. It is thereby provided that the energy supply unit is electrically connected on the one hand to an energy source and on the other hand to a transmission device designed to establish a safety extra-low voltage connection to the motor vehicle, and the energy supply unit can be controlled by means of a control unit to provide the energy for the motor vehicle, wherein the control unit is provided and designed to control a further energy supply unit said further energy supply unit can be arranged separately from the energy supply unit in the housing and can be electrically connected on the one hand to the energy source and on the other hand to the motor vehicle. A method for operating an energy supply device, a method for manufacturing energy supply devices and an energy supply arrangement are also provided.

### BACKGROUND

### Technical Field

Embodiments of the invention relate to an energy supply device for providing electrical energy to a motor vehicle, comprising an energy supply unit arranged in a housing. Embodiments of the invention further relate to a method of operating an energy supply device, a method of manufacturing energy supply devices, and an energy supply arrangement.

### Description of the Related Art

For example, DE 10 2011 007 839 A1 is known from the prior art. This describes a vehicle charging device, comprising a charging station outside a vehicle, a charging cable and an electrical charging system of the vehicle, for the charging of an electrical energy storage device of the vehicle with electrical energy from an external alternating current network, wherein the charging station can be supplied with electrical energy from the external alternating current network on the input side, the charging cable is electrically connected to the charging station or can be electrically connected to the charging station, the charging cable can be electrically connected to the electrical charging system by means of a plug-socket connection, the charging station has six electrical taps, the charging cable has six electrical lines and, in order to charge the electrical energy storage device, the six electrical taps of the charging station are connected to the six electrical lines of the charging cable with the same configuration and the six electrical lines of the charging cable are connected to at least four electrical contacts of the electrical charging system in the same way.

### BRIEF SUMMARY

The present disclosure proposes an energy supply device for providing electrical energy for a motor vehicle, which has advantages over known energy supply devices, in particular wherein the electrical energy can be provided in an extremely flexible manner in different configurations.

In some embodiments, an energy supply unit is electrically connected on the one hand to an energy source and on the other hand to a transmission device designed to establish a safety extra-low voltage connection to the motor vehicle and the energy supply unit can be controlled by means of a control unit to provide the energy for the motor vehicle, wherein the control unit is provided and designed to control a further energy supply unit, said further energy supply unit can be arranged separately from the energy supply unit in the housing and can be electrically connected on the one hand to the energy source and on the other hand to the motor vehicle.

The energy supply device is used to provide the electrical energy for the motor vehicle. The motor vehicle has, for example, an energy storage device for temporary storage of the electrical energy. It may therefore be provided that the electrical energy provided by the energy supply device can at least occasionally be used to charge the energy storage device of the motor vehicle.

In order to transmit the electrical energy from the energy supply device to the motor vehicle, the energy supply device has the energy supply unit. This is electrically connected to the energy source on the one hand and to the transmission device on the other hand. In other words, the transmission device is electrically connected to the energy source by means of the energy supply unit. The energy source is used to provide the electrical energy. For example, an energy grid, in particular a domestic energy grid and/or a public energy grid, is used as the energy source.

The transmission device may be a contact transmission device or a cable-based transmission device. The electrical connection between the energy supply unit and the motor vehicle is ultimately established by means of the transmission device. For example, the transmission device is in the form of a contact point or contact plate that is electrically contacted at least temporarily by a current collector of the motor vehicle.

The transmission device is used to establish the safety extra-low voltage connection, i.e., an electrical connection that is intended and designed for transmission of a safety extra-low voltage. To comply with safety regulations, the transmission device is therefore only supplied a safety extra-low voltage (SELV) by the energy supply unit. The safety extra-low voltage is characterized by the fact that it is at most 25 V for alternating current and at most 60 V for direct current.

The energy supply unit adjusts the electrical voltage present at the transmission device in such a way that it meets these conditions, i.e., only the safety extra-low voltage is present at the transmission device. The energy supply unit is controlled by the control unit for this purpose. For this purpose, the energy supply unit, for example, has an electrical switch, which is electrically arranged between the energy source and the transmission device. The switch can be controlled by the control unit. For example, in a first switch position of the switch there is an electrical connection between the energy source and the transmission device, whereas in a second switch position it is interrupted, so that the energy source and the transmission device are electrically separated from each other.

In order to enable a particularly flexible configuration of the energy supply device, the control unit is provided and designed for controlling the further energy supply unit. This is meant to indicate that the control unit is at least set out to control the further energy supply unit. For example, for this purpose, the control unit has a corresponding output for the further energy supply unit.

The additional energy supply unit can basically be arranged separately from the energy supply unit in the housing and can be electrically connected to the energy source on the one hand and to the motor vehicle on the other. The further energy supply unit is initially purely optional. It may therefore be envisaged that initially only the energy supply unit is arranged in the housing and is connected for its control to the control unit. However, the control unit is in any case set up to control the further energy supply unit.

In addition to the energy supply unit, the further energy supply unit can also be arranged in the housing or, alternatively in at least one embodiment of the energy supply device, it is present in the housing. In this case, it is electrically connected to the energy source on the one hand and electrically connectable to the motor vehicle on the other hand. For example, for this purpose, the further energy supply unit is electrically connected to a further transmission device. If the further energy supply unit is present in the housing, it is connected for control to the control unit.

The described energy supply device enables a particularly flexible and targeted supply of energy. It is therefore possible to configure the energy supply device, for example, according to customer requirements. In a first configuration, the energy supply device solely has the energy supply unit, but not the further energy supply unit. In a second configuration, both the energy supply unit and the further energy supply unit are present.

In further configurations, the energy supply device has more than one further energy supply unit, each of which is connected for control to the control unit. For example, the control unit is provided and designed for controlling the energy supply unit and at least two further energy supply devices. For this purpose, it has a corresponding number of outputs to which the energy supply unit and the at least one further energy supply unit can be connected.

A further development provides that the control unit has a communication device for communicating with a communication counterpart of the motor vehicle. The communication device serves to establish a communication link to the motor vehicle or to the communication counterpart of the motor vehicle. Via the communication link, the motor vehicle can, for example, specify at least one energy supply parameter on the basis of which the energy is provided. For example, an electrical voltage, an amount of electrical energy or the like is used as the energy supply parameter.

In any case, the communication device is a component of the control unit, so that ultimately the motor vehicle can respectively control the energy supply unit and the at least one further energy supply unit in a targeted manner by means of the communication device. As a result, a simple construction of the energy supply device is achieved, because there is only a single communication device for communicating with the motor vehicle for the plurality of energy supply units.

A further development provides that the further energy supply unit is electrically connected to a further transmission device designed for a low-voltage connection. Reference has already been made above to the further transmission device. This is designed for establishing the low-voltage connection to the motor vehicle. A voltage of at most 1,000 V in the case of alternating current and at most 1,500 V for direct current is meant when speaking of low-voltage. In any case, however, the electrical voltage applied to the further transmission unit by the further energy supply unit is higher than the voltage applied to the transmission device by the energy supply device.

For example, the voltage applied by the further energy supply unit to the further transmission device is more than 25 V, in particular at least 100 V, at least 200 V, at least 300 V, at least 400 V or at least 500 V, in the case of alternating current, and more than 60 V, in particular at least 100 V, at least 200 V, at least 300 V, at least 400 V, at least 500 V or at least 600 V, in the case of direct current.

In this respect, different charging processes can be achieved with the assistance of the energy supply unit and the further energy supply unit. For example, the additional energy supply unit can be used for fast charging of the motor vehicle, whereas the energy supply unit is designed for slower charging. In this way, a particularly flexible operation of the energy supply device is achieved.

One further embodiment provides that the energy supply unit and the further energy supply unit are electrically connected to a common energy connection of the housing separately from one another. The energy supply unit and the further energy supply unit are connected to the energy source by means of the energy connection of the housing. Since the energy supply unit and the further energy supply unit are separately connected to the common energy connection, the same voltage is applied to each of the units as is applied to the energy connection. The energy supply unit and the further energy supply unit adapt this voltage in such a way that the voltage applied to the transmission device and the further transmission device respectively is within the desired voltage range. The described embodiment of the energy supply device enables a simple construction.

A further development provides that the energy supply unit and the further energy supply unit are electrically connected to the common energy connection by means of a common rectifier. The common rectifier is electrically arranged between the energy connection on the one hand and the energy supply unit and the further energy supply unit on the other hand. The energy source provides alternating current at the energy connection, which is converted into direct current with the assistance of the rectifier, which is then supplied to the energy supply unit and the further energy supply unit. In this context, it may be provided that an output voltage of the rectifier is applied to both the energy supply unit and the further energy supply unit. The use of the common rectifier makes it possible to dispense with separate rectifiers, which permits a significant cost saving.

According to a further development, the energy supply unit is electrically connected to the common rectifier by means of a DC-to-DC converter and the further energy supply unit is electrically connected to the common rectifier by means of a further DC-to-DC converter. By means of the DC-to-DC converter and the further DC-to-DC converter, the output voltage provided by the common rectifier can be converted into another voltage or other voltages.

For example, a first voltage is provided with the assistance of the DC-to-DC converter of the energy supply unit and a second voltage is provided with the assistance of the further DC-to-DC converter of the further energy supply unit. The second voltage can correspond to the first voltage or be different from it.

In any case, the first voltage and the second voltage are different from the output voltage of the rectifier. Such an arrangement enables particularly flexible supply of electrical energy for the motor vehicle.

Additional embodiments relate to a method for operating an energy supply device for providing electrical energy for a motor vehicle, in particular an energy supply device according to the embodiments in the framework of this description, wherein the energy supply device has an energy supply unit arranged in a housing. It is thereby provided that the energy supply unit is electrically connected on the one hand to an energy source and on the other hand to a transmission device designed to establish a safety extra-low voltage connection and is controlled by means of a control unit for supplying the energy to the motor vehicle, wherein a further energy supply unit is arranged in the housing and is electrically connected on the one hand to the energy source and can be electrically connected on the other hand to the motor vehicle, wherein the further energy supply unit is controlled by means of the control unit for supplying the energy to the motor vehicle.

The advantages of such an approach or of such a design of the energy supply device have already been discussed. Both the energy supply device and the method for operating it can be further developed in accordance with the explanations in the framework of this description. In this respect, the energy supply device has both the energy supply unit and the further energy supply unit. Both are controlled by means of the same control unit, wherein the control unit may have the communication device for communication with the motor vehicle.

Additional embodiments relate to a method for producing energy supply devices for providing electrical energy for a motor vehicle, in particular energy supply devices which are each designed in accordance with the embodiments in the framework of this description, wherein each of the energy supply devices has an energy supply unit arranged in a housing. It is thereby provided that the energy supply unit is electrically connected on the one hand to an energy source and on the other hand to a transmission device designed to establish a safety extra-low voltage connection and which can be controlled by means of a control unit for providing the energy for the motor vehicle, wherein for a part of the energy supply devices, such as only for the part of the energy supply devices, a further energy supply unit is arranged in the housing and is electrically connected on the one hand to the energy source and on the other hand can be electrically connected to the motor vehicle, wherein the control unit is provided and designed for controlling the further energy supply unit.

Once again, reference is made to the explanations in the framework of this description with regard to the advantages and possible further developments of the energy supply devices or each of the energy supply devices.

Different energy supply devices can be manufactured in a simple manner by means of the process described. It is thus provided that in one part of the energy supply devices, only the energy supply unit, however not the further energy supply unit, is arranged in the housing. In a second part, on the other hand, both the energy supply unit and the further energy supply unit are arranged in the housing. The energy supply unit and the further energy supply unit are each controlled by means of the control unit. To this extent, they are each electrically connected to the control unit, if present.

In addition, some embodiments relate to an energy supply arrangement, having a motor vehicle and an energy supply device for providing electrical energy for the motor vehicle, in particular an energy supply device in accordance with the embodiments in the framework of this description, wherein the energy supply device has an energy supply unit arranged in a housing. It is thereby provided that the energy supply unit is electrically connected on the one hand to an energy source and on the other hand to a transmission device designed to establish a safety extra-low voltage connection to the motor vehicle and can be controlled by means of a control unit for supplying the energy to the motor vehicle, wherein the control unit is provided and designed for controlling a further energy supply unit which can be arranged separately from the energy supply unit in the housing and can be electrically connected on the one hand to the energy source and on the other hand to the motor vehicle.

When speaking of the energy supply device, reference is also made to the explanations in the framework of this description with respect to the advantages and further embodiments.

A further embodiment provides that the motor vehicle is electrically connected to the transmission device by means of a relocatable current collector and/or has an energy storage device for intermediate storage of electrical energy, which is electrically connected to the current collector by means of a DC-to-DC converter. The current collector is relocatable relative to a body of the motor vehicle, for example, with the assistance of an electric drive. The current collector serves to make electrical contact with the transmission device, so that the safety extra-low voltage connection between the energy supply unit and the motor vehicle can be or is established by means of the transmission device and the current collector.

Additionally, or alternatively, the motor vehicle has the energy storage device. The DC-to-DC converter is electrically connected between the current collector and the energy storage device, by means of which DC-to-DC converter the electrical voltage provided at the current collector is converted into the electrical voltage used for charging the energy storage device. Since the electrical voltage provided at the current collector by the energy supply unit is a safety extra-low voltage, the DC-to-DC converter is used to increase the voltage, for example to a voltage that is higher than the safety extra-low voltage by a factor of at least 5, at least 7.5 or at least 10. This enables an effective charging of the energy storage device of the motor vehicle.

### BRIEF DESCRIPTION OF THE SEVERAL VIEWS OF THE DRAWINGS

FIG. 1 depicts a schematic representation of an energy supply arrangement in a first embodiment.

FIG. 2 depicts a schematic representation of an energy supply arrangement in a second embodiment.

FIG. 3 depicts a schematic representation of an energy supply arrangement in a third embodiment.

FIG. 4 depicts a schematic representation of an energy supply arrangement in a fourth embodiment.

### DETAILED DESCRIPTION

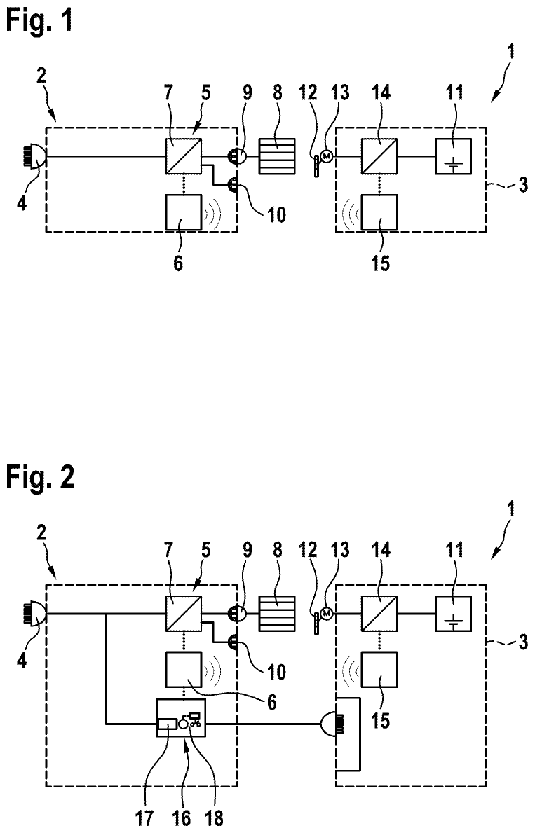

FIG. 1 depicts a schematic representation of an energy supply arrangement 1, which has an energy supply device 2 and a motor vehicle 3. The energy supply device 2 has an energy connection 4 for connecting the energy supply device 2 to an energy source not shown in more detail. Furthermore, an energy supply unit 5 and a control unit 6 are associated with the energy supply device 2. In the embodiment example depicted here, the energy supply unit 5 has a rectifier 7, by means of which alternating current provided at the energy connection 4 is converted into direct current.

The energy supply unit 5 is electrically connected on the one hand to the energy connection 4 and on the other hand to a transmission device 8. For example, the transmission device 8 is hereby connected to the energy supply unit 5 by means of a plug connector 9. In addition to the plug connector 9, a further plug connector 10 can be connected to the energy supply unit 5, in particular in parallel with the plug connector 9.

The motor vehicle 3 has an energy storage device 11 for intermediate storage of electrical energy, a current collector 12 which can be relocated by means of an electrical drive 13, a voltage converter 14 and a communication counterpart 15. The energy storage device 11 is electrically connected to the current collector 12 by means of the voltage converter 14. The current collector 12 can be brought into contact with the transmission device 8 by means of the drive 13, in the case in which the motor vehicle 3 is accordingly arranged with respect to the energy supply device 2. A safety extra-low voltage connection is hereby established between the energy supply unit 5 and the motor vehicle 3 by means of the transmission device 8 and the current collector 12.

Due to the low voltage applied to the current collector 12, the voltage converter 14 is used to increase the voltage. The voltage increased by means of the voltage converter 14 is then used to charge the energy storage device 11. For example, the motor vehicle 3 requests the supply of electrical energy by the energy supply unit 5 by means of the communication counterpart 15. For this purpose, the communication counterpart 15 establishes a communication link with a communication device of the control unit 6.

FIG. 2 depicts a schematic representation of the energy supply arrangement 1 in a second embodiment. The second embodiment substantially corresponds to the first embodiment, so that reference is made to the corresponding explanations and only the differences are discussed below. These differences lie in the fact that the energy supply device 2 has a further energy supply unit 16 in addition to the energy supply unit 5. This serves to establish a low-voltage connection to the motor vehicle 3, such as also by means of a wired connection. This is indicated purely by way of example.

Just like the energy supply unit 5, the energy supply unit 16 is controlled by the control unit 6, which is present as a common control unit. The further energy supply unit 16 is electrically connected to the energy connection 4 in parallel with the energy supply unit 5. Purely by way of example, it is here depicted that the energy supply unit 16 has an in-cable control and protecting device (ICCPD) 17 and/or an overload protection circuit 18. The energy supply unit 16 is designed as an alternating current charging unit, i.e., it is used to provide alternating current for the motor vehicle 3.

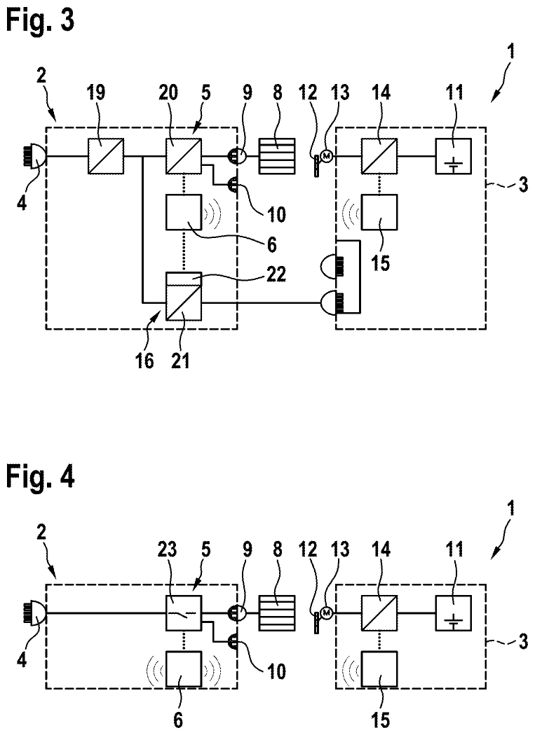

FIG. 3 depicts a schematic representation of the energy supply arrangement 1 in a third embodiment. This is similar to the second embodiment, so that reference is made to the corresponding explanations and again only the differences are discussed. These lie in the fact that the energy supply unit 16 is not designed as an alternating current charging unit, but rather as a direct current charging unit. For this purpose, the energy supply unit 5 and the energy supply unit 16 are electrically connected to the energy connection 4 by means of a common rectifier 19.

The energy supply unit 5 in this case therefore does not have the rectifier 7, but rather a voltage converter 20. The energy supply unit 16, on the other hand, has a voltage converter 21. The latter was, for example, controlled by a controller 22. Likewise, in the third embodiment example, the energy supply unit 5 and the energy supply unit 16 are both controlled by the common control unit 6.

FIG. 4 depicts a schematic representation of the energy supply arrangement 1 in a fourth embodiment. With regard to this, reference is again made to the above explanations, in particular to the first embodiment. In the following, the differences will be discussed. These essentially lie in the fact that direct current, rather than alternating current, is made available at the energy connection 4, namely from an energy storage device, for example, from a battery or an accumulator. The supply of electrical energy takes place at a voltage which corresponds to the voltage required to operate the energy supply unit 5. In this respect, the voltage is a safety extra-low voltage.

For example, it may be provided to first operate the energy supply arrangement 1 in the first embodiment, the second embodiment, or the third embodiment to charge an energy storage device by means of plug connector 10. Then, the charged energy storage device may be connected to the energy connection 4 of the energy supply arrangement 1 in the fourth embodiment, and the electrical energy extracted from the energy storage device may be used to charge the motor vehicle 3. In this respect, the energy supply unit 5 can be of a particularly simple design. For example, it merely has an electrical switch 23.

German patent application no. 102020106347.4, filed Mar. 9, 2020, to which this application claims priority, is hereby incorporated herein by reference, in its entirety. Aspects and features of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An energy supply device for providing electrical energy for a motor vehicle, the energy supply device comprising:
an energy supply unit arranged in a housing;
wherein the energy supply unit is electrically connected to an energy source and to a transmission device designed to establish a safety extra-low voltage connection to the motor vehicle;
wherein the energy supply unit can be controlled by a control unit to provide the energy for the motor vehicle;
wherein the control unit is designed to control a further energy supply unit; and
wherein said further energy supply unit can be arranged separately from the energy supply unit in the housing and can be electrically connected to the energy source and to the motor vehicle.

2. The energy supply device according to claim 1, wherein the control unit has a communication device for communicating with a communication counterpart of the motor vehicle.

3. The energy supply device according to claim 1, wherein the further energy supply unit is electrically connected to a further transmission device designed for a low-voltage connection.

4. The energy supply device according to claim 1, wherein the energy supply unit and the further energy supply unit are electrically connected to a common energy connection of the housing separately from one another.

5. The energy supply device according to claim 4, wherein energy supply unit and the further energy supply unit are electrically connected to the common energy connection by a common rectifier.

6. The energy supply device according to claim 5, wherein the energy supply unit is electrically connected to the common rectifier by a DC-to-DC converter and the further energy supply unit is electrically connected to the common rectifier by a further DC-to-DC converter.

7. A method for operating an energy supply device for providing electrical energy for a motor vehicle, the energy supply device comprising an energy supply unit arranged in a housing, wherein the energy supply unit is electrically connected to an energy source and to a transmission device designed to establish a safety extra-low voltage connection, wherein the energy supply unit can be controlled by a control unit for supplying the energy to the motor vehicle, wherein a further energy supply unit is arranged in the housing and is electrically connected to the energy source and can be electrically connected to the motor vehicle, wherein the further energy supply unit is controlled by the control unit for supplying the energy to the motor vehicle.

8. A method for producing energy supply devices for providing electrical energy for a motor vehicle, wherein each of the energy supply devices has an energy supply unit arranged in a housing, wherein the energy supply unit is electrically connected to an energy source and to a transmission device designed to establish a safety extra-low voltage connection, wherein the energy supply unit can be controlled by a control unit for supplying the energy to the motor vehicle, wherein for a portion of the energy supply devices, a further energy supply unit is arranged in the housing and is electrically connected to the energy source and can be electrically connected to the motor vehicle, wherein the control unit is designed for controlling the further energy supply unit.

9. An energy supply arrangement, comprising:
a motor vehicle;
an energy supply device for providing electrical energy for the motor vehicle;
wherein the energy supply device has an energy supply unit arranged in a housing;
wherein the energy supply unit is electrically connected to an energy source and to a transmission device designed to establish a safety extra-low voltage connection to the motor vehicle;
wherein the energy supply unit can be controlled by a control unit for supplying the energy to the motor vehicle; and
wherein the control unit is designed for controlling a further energy supply unit arranged separately from the energy supply unit in the housing and can be electrically connected to the energy source and to the motor vehicle.

10. The energy supply arrangement according to claim 9, wherein the motor vehicle is electrically connected to the transmission device by a relocatable current collector and/or has an energy storage device for intermediate storage of electrical energy, which is electrically connected to the current collector by a DC-to-DC converter.
